(19) United States
(12) Patent Application Publication
(10) Pub. No.: US 2005/0072799 A1
(43) Pub. Date: Apr. 7, 2005

(54) Beverage dispensing apparatus including a whipper insert and method

(76) Inventor: Gus J. Stratton, La Verne, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 10/880,933

(22) Filed: Jun. 30, 2004

Related U.S. Application Data
(63) Continuation-in-part of application No. 10/336,063, filed on Jan. 3, 2003.

(51) Int. Cl. B67B 7/00

(52) U.S. Cl. 222/129.1

(57) ABSTRACT

An apparatus for producing and dispensing a whipped beverage. The apparatus includes a mixing chamber, a syrup inlet 34 and a water inlet 42. The mixing chamber 26 has a dispensing nozzle through which a fluid-foam mixture effluent passes. The improvement includes a whipping insert 28 that is installed within the mixing chamber 26. The whipping insert 28 has a central hollow shaft defining an axial bore 76, a flange 23 extending radially from the shaft, and a perforated lower closure wall 59. The flange 23 defines a plurality of partially open channels that communicate with the axial bore 76, thus providing a syrup flow path. A water flow path extends from the water inlet via a plug valve 90 spirally into the mixing chamber 26. As the water impinges upon the syrup, fluid impact causes turbulence to occur that efficiently intermixes the syrup and the water to create the fluid-foam mixture before and dispensing through the dispensing nozzle.

### CROSS-REFERENCE TO RELATED APPLICATIONS

This application is a continuation-in-part of U.S. Ser. No. 10/336,063 filed Jan. 3, 2003, the disclosure of which is incorporated herein by reference.

### BACKGROUND OF THE INVENTION

1. Field of the Invention

The present invention relates generally to a beverage dispensing apparatus. More particularly, the invention concerns a novel apparatus and method for preparing and dispensing whipped beverages.

2. Background Art

Many types of restaurants offer a variety of soft drinks with their meal services. The soft drinks typically comprise a combination of syrup and carbonated or tap water. Certain types of soft drinks are dispensed in a whipped condition. In the prior art, the whipping step was typically accomplished using mechanical whipping means such as one or more propeller-like blades which are rotated at a relatively high rate of speed to whip the mixture of syrup and water. Exemplary of this type of apparatus is that described in U.S. Pat. No. 4,676,401 issued to Fox et al.

The rotating blade type of whipping apparatus is undesirable for several reasons. In the first place; if the mechanical portions of the apparatus are not continuously cleaned, the apparatus may jam and fail. Additionally, the National Sanitation Foundation (NSF) mandates at least daily cleaning of the prior art whipping apparatus and such cleaning is costly and time consuming. Further, the prior art mechanical mixing devices are typically quite expensive, are somewhat unreliable and generally require continual maintenance. During washing and maintenance, the apparatus is, of course, out of service and cannot be used to accomplish beverage dispensing thus causing costly downtime.

Another prior art beverage whipping apparatus, incorporated herein by reference, is described in U.S. Pat. No. 6,305,269 issued to the present inventor. That apparatus produces and dispenses whipped-soft drinks, such as hot chocolate and like beverages. More particularly, the apparatus whips and mixes by directing a stream of water within a vented mixing chamber to which a stream of syrup is also directed.

Conventionally, prior art beverage dispensers leave certain problems unsolved. For example, the formation of an undesirable amount of foam may occur during intermixing. Also, a whipped drink is generally more viscous than a non-whipped drink. In making whipped drinks, restrictions to the flow of syrup tend to impede efficient intermixing with water. Ultimately, complete intermixing may not occur until the syrup and the water are received in the bottom of a cup, often with the undesirable consequence of splashing.

### SUMMARY OF THE INVENTION

The thrust of the present invention is to provide a novel whipping insert that will efficiently mix a concentrate (e.g. syrup) and a diluent (e.g. water) and yet can be conveniently used with many types of commercially available, prior art beverage dispensers. In one form of the invention, the novel whipping insert is receivable in the mixing chamber of the beverage dispensing apparatus in place of a conventional diffuser which is normally provided with the beverage dispensing apparatus.

In contrast with prior approaches, the inventive insert causes aeration within the mixing chamber and promotes the efficient intermixing of the ingredients in the mixing chamber before those ingredients escape from the dispensing nozzle. Using one embodiment of the invention, mixing occurs before the fluid escapes through apertures in the floor of the insert.

In using the novel whipping insert of the present invention, the dispensing nozzle is first separated from the beverage dispensing apparatus and then the conventional diffuser is removed from the dispensing nozzle. A plug valve regulates the flow of water that enters a mixing chamber of the dispursing apparatus. The valve partially closes the channel along which the incoming stream passes so that it enters the chamber at an accelerated velocity. This done, the whipping insert of the invention is inserted into the mixing chamber of the dispensing nozzle. This step can be accomplished without otherwise modifying the prior art dispensing apparatus and without the use of any special tools. When in place within the mixing chamber, the plug valve and whipping insert of the invention strategically turbulates the water flowing into the mixing chamber in such a manner as to thoroughly intermix the water and the syrup that are flowing into the mixing chamber and, at the same time efficiently whip the syrup-water mixture.

It is an object of the present invention to provide a novel apparatus for producing and dispensing whipped soft drinks, hot chocolate and like beverages which does not use mechanical whipping means such as rotating blades, but rather intermixes the syrup and water and efficiently whips the mixture thus formed through the use of a plug valve and whipping insert that are receivable within the mixing chamber of the beverage dispensing apparatus.

Another object of the invention is to provide an apparatus of the aforementioned character, in which the plug valve and whipping insert cause the water flowing into the mixing chamber of the apparatus from the water source to course spirally within the chamber at a relatively high velocity. The water thus delivered impinges on the stream of syrup that flows via the whipping insert into the mixing chamber from the syrup source. As the spirally-flowing water impinges on a distributed stream of syrup, it causes a substantial turbulence to occur that efficiently intermixes the syrup and water and effectively whips the mixture before it is dispensed through the outlet portion of the dispensing nozzle of the beverage dispensing apparatus.

Another object of the invention is to provide a mixing apparatus which requires little maintenance, is easy to operate, and is highly reliable in continuous use.

A further object of the invention is to provide an apparatus of the character described in the preceding paragraphs, which is of a simple construction, can be inexpensively produced, and can be used with various types of prior art beverage dispensing devices.

The whipping insert has a central hollow shaft that defines an axial bore which terminates in a closed end. A flange extends radially from the shaft. The flange defines a plurality of radially extending partially open channels that communicate with the axial bore to provide a distributed, syrup flow path in the mixing chamber that extends from the syrup inlet and passes downwardly through the bore towards its closed end and radially outwardly from the bore along the channels.

The flange also defines a perimeter that is spaced apart from the inner wall of the mixing chamber to form an annular space therebetween. A water flow path is thus provided that extends from the water inlet into the mixing chamber outwardly of the central hollow shaft before impinging upon the syrup that flows outwardly from the axial bore.

A fluid-foam mixture is then created by turbulent intermixing between the syrup and the water. The mixture passes over the flange and downwardly and outwardly across the annular space. The mixture is then dispensed through the perforated lower closure wall and the dispensing nozzle.

These and other objects of the invention will become apparent from the description, which follows.

### BRIEF DESCRIPTION OF THE DRAWINGS

FIG. 1 is a side-elevational view, partly in cross section, of one form of the apparatus of the invention within which a whipping insert according to the invention is placed;

FIG. 2 is a perspective, exploded view of the dispensing nozzle and inventive whipping insert of the apparatus of the invention shown in FIG. 1;

FIG. 3 is a side view of the whipping insert;

FIG. 4 is the bottom view thereof; and

FIG. 5 is a top view thereof.

### DETAILED DESCRIPTION OF THE PREFERRED EMBODIMENT(S)

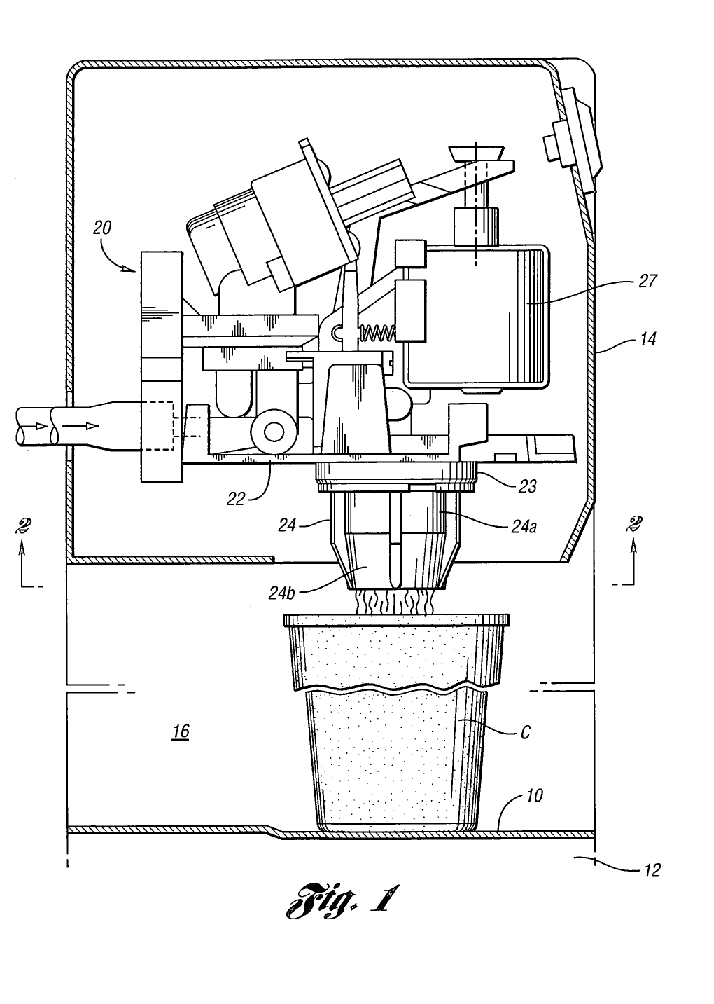

Referring to FIG. 1 of the drawings for an understanding of the environment of the invention, one embodiment of apparatus for producing and dispensing a whipped beverage is shown. This apparatus comprises a base unit 12, a hollow housing 14 located over base 12 and a back panel 16 interconnecting base unit 12 and hollow housing 14. Disposed within hollow housing 14 is a mixing means for mixing a concentrate such as the syrup and a diluent, such as water to produce the whipped beverage.

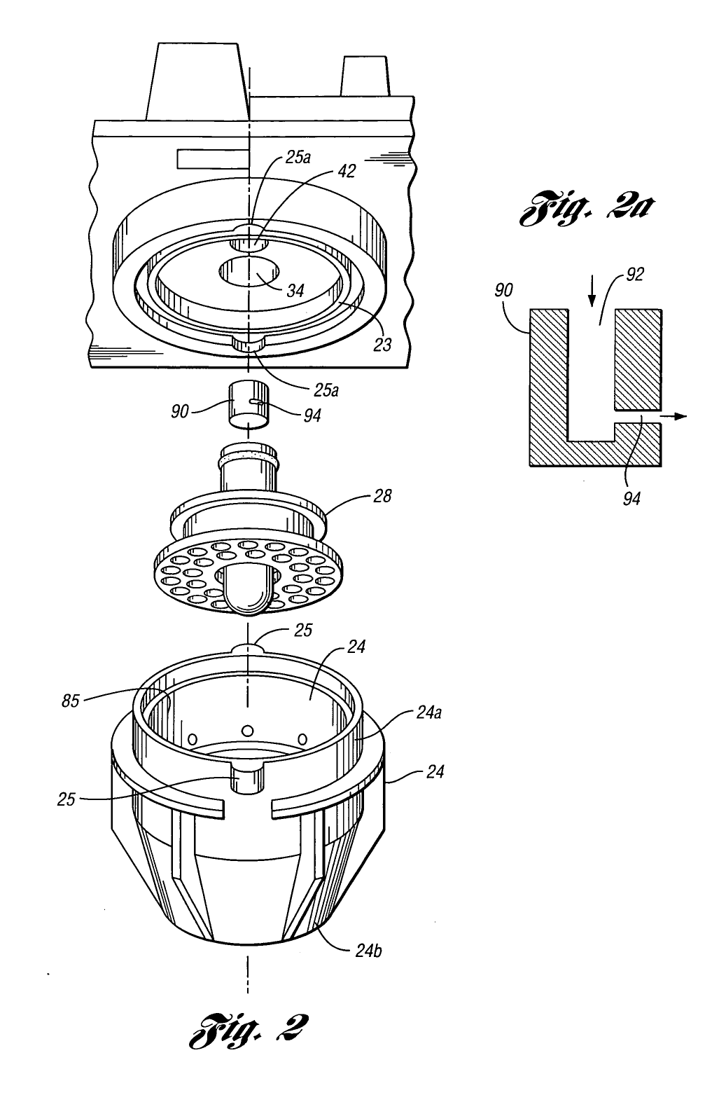

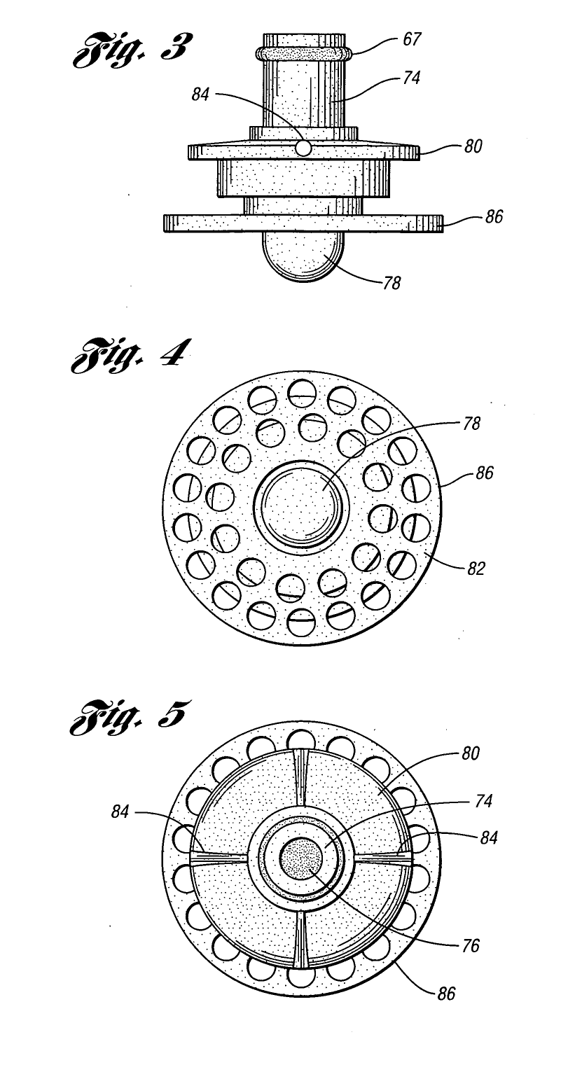

Forming a part of the mixing means is a mounting block assembly 20 of generally conventional construction which includes bottom plate 22 and a downwardly extending the flange 23. A hollow member 24 having an upper, generally cylindrically shaped portion 24a and a lower, inwardly tapering dispensing nozzle portion 24b is removably connected to bottom plate 22 by a bayonet type locking mechanism that includes circumferentially spaced ears 25 (FIG. 2) that are receivable within openings 25a formed in the bottom plate. Rotation of member 24 relative to the bottom plate 22 in the manner shown in FIG. 2, will lock the member in position. Formed within upper, generally cylindrically shaped portion 24a of member 24 is a mixing chamber 26 that is of the configuration best seen in FIG. 2. Receivable within mixing chamber 26 is the whipping insert 28 of the invention (FIGS. 2-5), the details of construction of which will presently be described.

The dispensing apparatus, or mixing means shown in FIG. 1 is generally similar in construction to several commercially available beverage dispensers, save for the fact that the commercially available dispensers include a diffuser (not shown) that is mounted within the mixing chamber, rather than the whipping insert of the present invention. One source of such a prior art beverage dispenser is the Commercial Refrigeration Service, Inc. of Phoenix, Ariz. Without the existence of a whipping insert of the invention, the prior art beverage dispensers do not dispense the uniquely whipped beverages that are dispensed by the apparatus of the present invention.

Referring now to FIGS. 2-5, the mixing chamber 26 is in communication with the syrup inlet 34 and the water inlet 42. It will be appreciated that the term “syrup” generally exemplifies a concentrate of some fluid form, i.e., an amount of a given substance in the form of a mixture or solution, such as a sugar or other sweetener together with a coloring agent. In general, the term “water” exemplifies a diluent, i.e., an ingredient that is used to reduce the concentration of an active material to achieve a desirable and beneficial effect. Such diluents may include an organic liquid having little solvent power which reduces viscosity and achieves suitable application properties, such as thinning.

The mixing chamber 26 has a ledge defined within an inner wall 88 (FIG. 2). The mixing chamber 26 terminates in the lower inwardly tapering dispensing nozzle portion 24(b) thereof through which a fluid foam mixture effluent passes. The whipping insert 28 is receivable within the mixing chamber 26. The whipping insert 28 has a central hollow shaft 74 which defines an axial bore 76 extending therewithin that terminates in a closed end 78.

Extending radially from the central hollow shaft 74 is a flange 80. The flange 80 has a plurality of radially extending partially open channels 84 that communicate with the axial bore 76. The portion of the channels 84 that are open are those portions that lie radially outwardly of the central hollow shaft 74. The channels 84 provide a distributed, syrup flow path that extends from the syrup inlet 34 and passes downwardly through the bore 76 toward its closed end 78 before passing radially outwardly from the bore 76 along the channels 74.

The flange 80 terminates in a perimeter 86 that is spaced apart from the inner wall 88 of the mixing chamber 26 to form an annular space therebetween.

As best seen in FIG. 2A, a plug valve 90, inserted into the water inlet 42, regulates the flow of water that enters a mixing chamber 26 of the dispursing apparatus. The valve 90 partially closes the channel 42 along which the incoming stream passes through an ingress port 92 of the plug 90 so that it enters the chamber 26 at an accelerated velocity through an egress port 94. A water flow path is thus provided that extends from the water inlet 42 through the plug 90 into the mixing chamber 26 outwardly of the central hollow shaft 74 before impinging upon the syrup that flows outwardly from the axial bore 76 along the channels 84.

In this manner, as the water impinges upon the syrup, fluid impact causes turbulence to occur that efficiently intermixes the syrup and the water to create a fluid-foam mixture. The mixture passes over the flange and downwardly and outwardly across the annular space. A perforated lower closure wall 59 is provided upon the whipping insert 28. The lower closure wall 82 serves further to distribute the fluid-foam mixture as it passes therethrough before emerging from the lower portion 24b of the dispensing nozzle.

In practicing the present invention, the velocity at which syrup is introduced into the mixing chamber is about one-fifth of the velocity at which water is introduced. Ideally, the ratio of foam to total effluent is about 30% by volume.

Assembly of the apparatus of the present invention can be accomplished by first removing the hollow housing 24 from a selected prior art beverage dispenser by rotating the hollow housing in a manner to align ears 25a with openings 25. With the hollow housing 24 removed, the diffuser supplied with the prior art beverage dispenser can be removed from hollow housing 24 and replaced by the whipping insert 28 of the present invention. If not already installed, the plug 90 can then be seated into the water inlet 42 through a snap-fit or interference engagement. This done, hollow housing 24 can be reconnected with the mounting block using the bayonet fitting in the manner illustrated in the drawings. A conventional O-ring 67 sealably into connects hollow housing 24 with the mounting block.

After the whipper insert is properly positioned within hollow housing 24, the flow of water and syrup through the mounting block can be commenced.

As indicated in FIG. 1, the nozzle portion 24b of hollow housing 24 is superimposed over a cup-supporting platform 70, which forms a part of base unit 12. The cup-supporting platform 70 is adapted to support a receptacle such as beverage cup “C” in the manner shown in FIG. 1.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An apparatus for producing and dispensing a whipped beverage having a mixture of syrup and water, the apparatus including:
a mixing chamber in communication with a syrup inlet and a water inlet, the mixing chamber having a dispensing nozzle through which a fluid-foam mixture effluent passes,
the improvement comprising
a whipping insert receivable within the mixing chamber, the whipping insert having:
a central hollow shaft defining a bore extending therewithin that terminates in a closed end;
a flange that extends radially from the shaft, the flange defining a plurality of radially extending channels that communicate with the axial bore to provide a distributed, syrup flow path that extends from the syrup inlet, passes downwardly through the bore toward its closed end and radially outwardly from the bore along the channels, and
a perimeter that is spaced apart from the inner wall of the mixing chamber to form an annular space therebetween to provide a water flow path that extends from the water inlet into the mixing chamber outwardly of the central hollow shaft before impinging upon the syrup that flows outwardly from the axial bore,
so that as the water impinges upon the syrup, fluid impact causes turbulence to occur that efficiently intermixes the syrup and the water to create the fluid-foam mixture before the mixture passes over the flange and downwardly and outwardly across the annular space, and is dispensed through the dispensing nozzle.

2. The apparatus as defined in claim 1, further a plug valve that is seated within the water inlet.

3. The apparatus as defined in claim 1 wherein the housing has an internal mixing chamber with an axial centerline, in which the syrup inlet is substantially aligned with the axial centerline.

4. The apparatus as defined in claim 1, further include means for sealing located around the central hollow shaft for providing a fluid-tight engagement between the shaft and the syrup inlet.

5. The apparatus as defined in claim 1, wherein the plurality of radially extending partially open channels comprises four channels.

6. The apparatus as defined in claim 1, wherein syrup enters the mixing chamber at a velocity which is about one-fifth of a velocity at which water enters the mixing chamber.

7. The apparatus as defined in claim 1, wherein the fluid-foam mixture includes about 30% by volume of foam.

8. The apparatus as defined in claim 2, wherein the plug valve includes an ingress port which receives water flowing through the water inlet and an egress port having a diameter less than that of the ingress port so that water entering the mixing chamber flows at an accelerated velocity in relation to that at which water flows through the water inlet.

9. The apparatus as defined in claim 8, wherein the egress port is oriented so that accelerated water entering the mixing chamber moves initial tangentially and then spirally within the mixing chamber before intermixing with syrup that escapes from the channels defined within the flange of the insert.

10. The apparatus as defined in claim 1, further including a perforated lower closure wall that is seated within the mixing chamber through which the fluid-foam mixture passes upon emergence from the mixing chamber before being received by a drinking vessel placed therebelow.

11. A method for modifying a beverage dispensing apparatus that includes a mixing chamber into which syrup and water flow, comprising the steps of:
removing a diffuser from within the mixing chamber; and
placing a whipping insert according to claim 1 within the mixing chamber to promote the mixing of syrup and water before the mixture is dispensed through a dispensing nozzle.

12. The method of claim 11 further including the step of:
inserting a plug valve into the water inlet, the plug valve regulating the flow water that enters the mixing chamber so that such water enters the chamber at an accelerated velocity in relation to that at which water arrives at the water inlet.
